(19) United States
(12) Patent Application Publication
(10) Pub. No.: US 2004/0041288 A1
(43) Pub. Date: Mar. 4, 2004

(54) Apparatus and method for fabricating an optical fiber preform with a large aperture

(76) Inventors: Young-Sik Yoon, Chilgok-gun (KR); Young-Min Baik, Kumi-shi (KR)

Correspondence Address: CHA & REITER, LLC, 210 ROUTE 4 EAST, PARAMUS, NJ, 07652, US

(21) Appl. No.: 10/641,639

(22) Filed: Aug. 14, 2003

(30) Foreign Application Priority Data
Aug. 29, 2002 (KR) 2002-51360

(51) Int. Cl. B29D 11/00; G02B 1/00; G02B 6/18

(52) U.S. Cl. 264/1.21; 264/1.24; 264/2.1; 425/267

(57) ABSTRACT

A method for fabricating large aperture optical fiber preform using a sintering apparatus for gel tube, includes the steps of: forming a uniform sol by mixing/dispersing for mixing fumed silica with deionized water, and adding a dispersing additive to form uniform sol; injecting the sol into a mold with a certain tubular form, and then gellifying the sol; demolding the tube-shaped gel from the mold; drying the tube-shaped gel; processing (or Binder burn-out & Purification) organic compounds including remaining moisture, alkali metallic impurities, and hydroxides in the gel; inserting a primary preform into the tube-shaped gel and then fastening the preform; and after arranging the gel with the primary preform therein into a sintering apparatus, sintering/over cladding the gel with the primary preform therein under vacuum atmosphere at high temperature.

### CLAIM OF PRIORITY

This application claims priority to an application entitled “APPARATUS OF SINTERING FOR GEL TUBE AND METHOD FOR FABRICATING LARGE APERTURE OPTICAL FIBER PREFORM USING THEREOF,” filed in the Korean Intellectual Property Office on Aug. 29, 2002 and assigned Serial No. 02-51360, the contents of which are hereby incorporated by reference.

### BACKGROUND OF THE INVENTION

1. Field of the Invention

The present invention generally relates to method for fabricating an optical fiber preform, and more particularly, to method for fabricating an optical fiber preform having a large aperture using sol-gel process.

2. Description of the Related Art

In general, an optical fiber is made up of different materials known as an inner core having a designated curvature, and a cladding, which has a lower curvature than the inner core. The fabrication of an optical fiber involves preparing an optical fiber preform and drawing a thin optical fiber from the preform to produce an optical fiber cable. The optical fiber preform goes through an over cladding process or over-jacketing process to draw the optical fiber out of the preform. This is achieved by over cladding or over acketing the primary optical fiber preform with tube-type secondary optical fiber preform, so that a large aperture optical fiber preform can be obtained. One known method for fabricating the secondary optical fiber preform, namely silica glass is a chemical-vapor deposition method or sol-gel process.

FIG. 1 is a flow chart illustrating a known sol-gel process. Briefly, the fabrication process of the secondary preform based on the sol-gel process mainly includes mixing/dispersing 110, molding 120, demolding 130, drying 140, processing (or Binder burn-out & Purification) of organic compounds 150 and sintering 160.

At the mixing/dispersing step 110, starting material is mixed with deionized water, and added to an additive, e.g., dispersing additive, to make a uniform sol. As for the starting material, silicon alkoxide or fumed silica is used.

At the molding step 120, the sol, which has been prepared by the mixing/dispersing step 110, is put in a mold with a certain predetermined shape, and gellified. Normally, a binder or gellification accelerator is added to the sol so as to strengthen binding among the sol particles. The actual mold is usually made of stainless steel, acryl, polystyrene, or Teflon material. Particularly, a mold for molding a sub-straight tube or over-jacketing tube has a cylindrical shape wherein a bar is inserted into the mold's center. To put the sol into the mold, one may simply pour the sol into the mold, or supply the sol to the mold by using height difference between the mold and the sol reservoir. However, these methods have drawbacks because of the possible risk of impurities inflowing and because of reduced productivity. Therefore, the more common practice is for one to use a pump to pour the sol into the mold.

At the demolding step 130, the gel that was formed inside of the mold during molding step 120, is separated from the mold and matured. The demolding step 130 is often carried out in the water tank to prevent any possible damage to the gel during the process.

At the drying step 140, the gel, which is preferably tube-shaped, having been separated from the mold at step 130, is dried by using a drying means like a constant temperature & humidity chamber. Here, as the moisture contained in the gel evaporates, the gel forms a porous retinal structure.

At the processing (or Binder burn-out & Purification) of organic compounds step 150, organic compounds, such as, the remaining moisture and the binder left inside of the gel, are decomposed through low-temperature heat treatment, and the gel is heated under chlorine gas atmosphere to remove alkali metallic impurities and hydroxides from the gel.

At the sintering step 160, the tube-shaped gel, which has been through processing (or Binder burn-out & Purification) of organic compounds step 150, is then sintered and glassified, thereby producing final product, namely silica glass.

More specifically, the sintering step 160 is performed in a sintering furnace at approximately 1500° C. under a vacuum atmosphere.

However, problems were found in the above-mentioned conventional method for fabricating the gel tube. For example, at the sintering step, the cross sectional area of the gel tube's upper end and lower end had different-sized diameters. Also, this difference in the diameter consequently caused a significantly larger number of the gel tubes to be discarded as defects rather than was available for use in actual production during the fabrication process of large aperture optical fiber preform.

### SUMMARY OF THE INVENTION

The present inventors discovered that the prior art problems could be overcome by inserting a primary preform that has the same length with the gel tube into the gel tube prior to the sintering step. In this way, the diameter difference between the upper end and the lower end, which usually happened after the sintering process, can be minimized, and since the gel tube consumed for the sintering step is decreased, productivity got improved also. In addition, as the sintering does not need to be excessively high any more, facility cost could be cut. Further, by inserting the primary preform into the gel tube before the sintering step, the entire optical fiber preform fabrication process was greatly shortened.

It is, therefore, an object of the present invention to provide a method for fabricating large aperture optical fiber preform. More specifically, a sol-gel fabrication method that is capable of reducing the amount of gel tube loss and minimizing diameter difference between the gel tube's upper end and lower end is disclosed herein.

To achieve the above objects, the inventors provide a method for fabricating large aperture optical fiber preform using a sintering apparatus for gel tube, the method including the steps of: mixing/dispersing for mixing fumed silica with deionized water, and adding a dispersing additive to form a uniform sol; gellifying the sol after injecting the sol into a mold with a certain form (tube),; demolding (separating) the gel from the mold; drying the tube-shaped gel; processing (or Binder burn-out & Purification) organic compounds including remaining moisture, alkali metallic impurities, and hydroxides in the gel; inserting a primary preform into the tube-shaped gel and then fastening the preform; and after building the gel with the primary preform therein into a sintering apparatus, sintering/over cladding the gel with the primary preform therein under vacuum atmosphere at a high temperature.

### BRIEF DESCRIPTION OF THE DRAWINGS

The above and other objects, features and advantages of the present invention will become more apparent from the following detailed description when taken in conjunction with the accompanying drawings in which:

FIG. 1 is a flow chart illustrating gel tube fabrication method based on a sol-gel process of a related prior art;

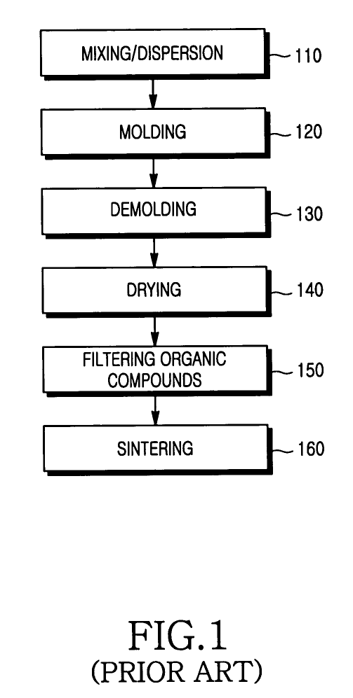

FIG. 2 is a flow chart illustrating gel tube fabrication method based on sol-gel process according to the present invention; and

FIG. 3 is a cross-sectional view of a gel tube fabrication apparatus based on the sol-gel process according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

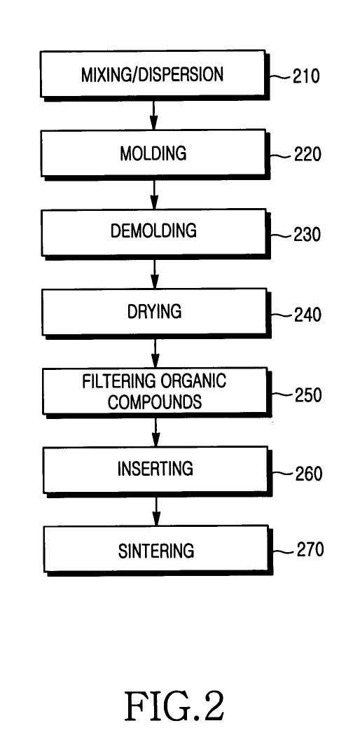

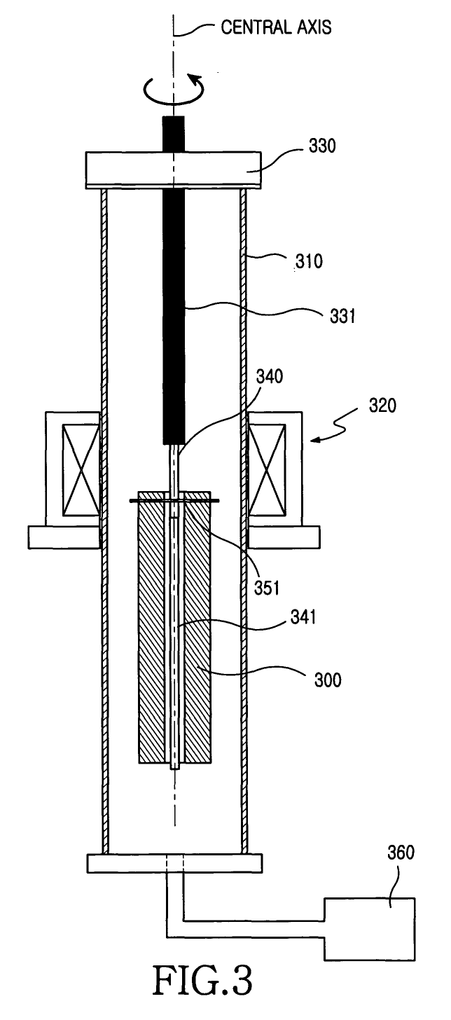

FIG. 2 is a flow chart illustrating gel tube fabrication method based on sol-gel process according to the present invention, and FIG. 3 is a cross-sectional view of a gel tube fabrication apparatus based on the sol-gel process according to the present invention.

The secondary preform fabrication method using the sol-gel according to the present invention includes a mixing/dispersing step 210, a molding step 220, a demolding step 230, a drying step 240, a processing (or Binder burn-out & Purification) of organic compounds step 250, an inserting step 260, and a sintering/over cladding step 270.

At the mixing/dispersing step 210, a starting material is mixed with deionized water, and added to an additive, e.g., dispersing additive, to make a uniform sol. A binder or gellification accelerator is usually added to the sol to strengthen binding among the sol particles.

For instance, according to the sol-gel process for forming a sol, starting material, i.e., fumed silica, is dispersed into deionized water, and a dispersing additive, a binder, and a plasticizer are added to improve dispersion.

The dispersed sol is mixed with deionized water until its acidity becomes about 12 and its viscosity about 40 cP. Then, the sol is matured for approximately 12 hours, and air bubbles therein are removed under vacuum atmosphere below 10⁻³ torr for the period of 10 minutes or so. Following this, gellification hardner is uniformly mixed with the sol.

At the molding step 220, the sol, which is prepared by the mixing/dispersing step 210, is put in a mold with a certain shape (e.g., tube), and gellified. The mold is usually made of stainless steel, acryl, polystyrene, or Teflon material. Particularly, a mold for molding a sub-straight tube or over-jacketing tube has a cylindrical shape where a brass rod is inserted to the center. Previously, for putting the sol into the mold, one simply poured the sol into the mold, or supplied the sol to the mold by using height difference between the mold and the sol reservoir. However, these methods turned out to be deficient in terms of the possible risks of impurities inflow and productivity. Therefore, it is common to use a pump to pour the sol into the mold.

For example, at the molding step 220, the matured sol through the mixing/dispersing step 210 is inserted into a centrifugal forming mold with the aforementioned shape, and sealed up. Then, vacuum treatment was performed for about 5 minutes under 10⁻³ torr. Again, the centrifugal forming mold is installed to the rotation shelf, and rotated at a high speed greater than 1,000 to 2,000 RPM for longer than 30 to 60 minutes. Lastly, this hardened sol-gel is placed in a chamber at about 3° C., and rotated at a low speed about 0.1 RPM.

The demolding step 230 involves the separation of tube-shaped gel from the mold that has been formed through the molding step 220. The demolding step is often conducted inside the water tank to prevent any damages on the gel during the demolding process.

At the drying step 240, the tube-shaped gel, which has been separated from the mold, is then dried by using a drying means, such as, a constant temperature & humidity chamber. As the moisture contained in the gel evaporates, the gel forms porous retinal structure.

At the processing (or Binder burn-out & Purification) of organic compounds step 250, organic compounds including moisture and the binder inside of the gel are decomposed through low-temperature heat treatment, and the gel is heated under chlorine gas atmosphere to remove alkali metallic impurities and hydroxides from the gel.

Referring to FIG. 3, the apparatus for sintering the gel tube includes a rotary air cylinder type processing tube 310, a ceramic bar 331 for transferring rotary power to an upper cap 330 that seals up the upper end 310b of the processing tube 310 and to the gel tube 300, heating (sintering) furnace 320 for sintering the gel tube, dummy bar 340 for connecting the ceramic bar 331 with the primary preform 341, connecting pin 351 for connecting upper portion of the gel tube 300 with the dummy bar 340 by penetrating the dummy bar 340, and vacuum apparatus 360 for making the interior of the sintering furnace a vacuum.

At the inserting step 260, primary preform 341, which has the same length as the gel tube 300 and an outside diameter within the range of general tolerance limits and an inside diameter of the gel tube, is inserted inside of the gel tube 300. By inserting the primary preform 341 into the center of the gel tube 300, up, down, and diameter deflections after process can be minimized.

Dummy bar 340 makes a junction with the lower portion of the ceramic bar 331 being connected with the upper cap 330, and the primary preform 341 is coupled with the lower end of the dummy bar 340. After inserting the primary preform 341 into the gel tube 300, the primary preform is bonded with the ceramic bar 331, and the connecting pin 351 is put in such way that to pass through the upper portion of the gel tube 300 and the upper portion of the dummy tube 340, thereby supporting the gel tube 300 and the primary preform 341.

At the sintering step 270, the tube-shaped gel, which has been filtered through the organic compounds processing (or Binder burn-out & Purification) step 250, is then sintered and glassified, thereby producing a final product, namely silica glass. The sintering step involves heating the dry and organic compound free-gel in a sintering furnace at high temperature under vacuum atmosphere.

More specifically, the sintering step 270 involves heating the gel tube 300 at the central part of the sintering furnace, i.e., the heating furnace 320 that is positioned at a junction of the gel tube 300 and the primary preform 341, and sintering the heated gel tube 300. In addition, the gel tube 300 and the primary preform 341 manifest different thermoreaction properties due to different structure and material used therein. That is, the sintering step 270 invokes condensation of the gel tube 300, and creates a high-temperature area between outer wall of the primary preform 341 and inner wall of the gel tube 300, that consequently makes the gel tube condense onto the outer wall of the primary preform to be more tightly adhered thereto. Moreover, the connection of the sintering furnace with a vacuum pump 320 improves the bonding effect between the primary preform 341 and the gel tube 300.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for fabricating large aperture optical fiber preform using a sintering apparatus for a gel tube, the method comprising the steps of:
(a) forming a uniform sol by mixing/dispersing fumed silica with deionized water, and adding a dispersing additive thereto;
(b) injecting the sol into a mold having a predetermined form;
(c) gellifying the sol;
(d) demolding the gel by separating the gel from the mold;
(e) drying the gel;
(f) processing organic compounds including remaining moisture, alkali metallic impurities, and hydroxides from the gel;
(g) inserting a primary preform into the gel and then fastening the preform; and
(h) after arranging the gel with the primary preform therein into a sintering apparatus, sintering/over cladding the gel with the primary preform therein under a vacuum atmosphere at high temperature.

2. The method according to claim 1, wherein the mold in step (b) has a tubular shape so as to form a gel-tube.

3. The method according to claim 1, wherein step (a) includes adding one of a binder and a gellification accelerator.

4. The method according to claim 1, wherein step (a) includes adding a plasticizer.

5. The method according to claim 1, wherein the mold used is a centrifugal forming mold rotated at an approximate speed greater than 1000 to 2000 revolutions per minute for at least 30 to 60 minutes.

6. The method according to claim 1, wherein the processing of organic compounds step includes low-temperature heat treatment, and the gel is heated under a chlorine gas atmosphere.

7. The method according to claim 2, wherein the primary preform inserted in step (g) has a same approximate length as the gel tube or a substantially shorter length that that of the gel tube.

8 The method according to claim 7, wherein the length difference between the primary perform and the gel tube is substantially less than 5%.

9. The method according to claim 2, wherein the primary preform is inserted into a center of the gel tube.

10. The method according to claim 2, wherein the sintering step includes invoking condensation of an inner wall of the gel tube onto an outer wall the primary preform.

11. Tubular silica glass having a deflectionless diameter according to the process of claim 2.

12. Tubular silica glass having a deflectionless diameter according to the process of claim 10.

13. A gel tube having a deflectionless diameter according to the process of claim 2.

14. A sintering apparatus for a gel tube fabricated by a sol-gel process that comprises:
a rotary air cylinder type processing tube mounted with a gel tube having a primary preform therein and an upper cap for sealing an upper end of the processing tube;:
a ceramic bar penetrating the upper cap and being inserted into the processing tube, said ceramic bar supporting the gel tube and the primary preform and permitting the transference of rotational power to the gel tube and the primary preform;
a dummy bar inserted between a lower end of the ceramic bar and an upper end of the primary preform, for bonding the ceramic bar to the primary preform;
a connecting pin for supporting the gel tube by penetrating the dummy bar and having both ends lay over the gel tube;
a sintering furnace, being fixated on an outer wall of the processing tube, for heating and then sintering the gel tube and for over-cladding the gel tube and the primary preform; and
a vacuum pump, being connected to the processing tube, for making inside of the sintering furnace vacuum state.

15. The apparatus according to claim 14, wherein the vacuum pump provides a vacuum state of approximate 10⁻³ torr.
